(19) United States
(12) Patent Application Publication
(10) Pub. No.: US 2020/0195944 A1
(43) Pub. Date: Jun. 18, 2020

(54) SLICE SIZE MAP CONTROL OF FOVEATED CODING

(71) Applicant: Advanced Micro Devices, Inc., Santa Clara, CA (US)

(72) Inventors: Darren Rae Di Cera, Reservoir (AU); Stephen Mark Ryan, Lilydale (AU)

(21) Appl. No.: 16/221,182

(22) Filed: Dec. 14, 2018

(51) Int. Cl. H04N 19/33; H04N 19/167; H04N 19/176; G02B 27/01

(52) U.S. Cl. CPC H04N 19/33; G02B 27/017; H04N 19/176; H04N 19/167

(57) ABSTRACT

Systems, apparatuses, and methods for adjusting the compression level for blocks of a frame based on a distance of each block to the focus region are disclosed. A system includes a transmitter sending a video stream over a wireless link to a receiver. The transmitter compresses frames of the video stream prior to sending the frames to the receiver. For each block of pixels of a frame, the transmitter selects a compression level to apply to the block based on the distance from the block to the focus region, with the compression level increasing the further the block is from the focus region. The focus region is the portion of a half frame where each eye is expected to be focusing when viewed by a user. The transmitter encodes each block with the selected compression level and then conveys the encoded blocks to a receiver to be displayed.

### BACKGROUND

### Description of the Related Art

A wireless communication link can be used to send a video stream from a computer (or other device) to a virtual reality (VR) headset (or head mounted display (HMD). Transmitting the VR video stream wirelessly eliminates the need for a cable connection between the computer and the user wearing the HMD, thus allowing for unrestricted movement by the user. A traditional cable connection between a computer and HMD typically includes one or more data cables and one or more power cables. Allowing the user to move around without a cable tether and without having to be cognizant of avoiding the cable creates a more immersive VR system. Sending the VR video stream wirelessly also allows the VR system to be utilized in a wider range of applications than previously possible.

Wireless VR video streaming applications typically have high resolution and high frame-rates, which equates to high data-rates. However, the link quality of the wireless link over which the VR video is streamed has capacity characteristics that can vary from system to system and fluctuate due to changes in the environment (e.g., obstructions, other transmitters, radio frequency (RF) noise). The VR video content is typically viewed through a lens to facilitate a high field of view and create an immersive environment for the user. It can be challenging to compress VR video for transmission over a low-bandwidth wireless link while minimizing any perceived reduction in video quality by the end user.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a system.

FIG. 2 is a block diagram of one implementation of a wireless virtual reality (VR) system.

FIG. 3 is a block diagram of one implementation of control logic for determining how much compression to apply to blocks of a frame being encoded.

FIG. 4 is a diagram of one implementation of concentric regions, corresponding to different compression levels, outside of a focus region of a half frame.

FIG. 5 is a diagram of one implementation of clipping of the scaled target slice sizes.

FIG. 6 is a diagram of another implementation of clipping of the scaled target slice sizes.

FIG. 7 is a generalized flow diagram illustrating one implementation of a method for adjusting a compression level based on distance from the focus region.

FIG. 8 is a generalized flow diagram illustrating one implementation of a method for selecting an amount of compression to apply to blocks based on distance from the focus region.

FIG. 9 is a generalized flow diagram illustrating one implementation of a method for adjusting a size of a focus region based on a change in the link condition.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Various systems, apparatuses, methods, and computer-readable mediums for adjusting the compression level used for compressing blocks of a frame based on a distance of each block to the focus region are disclosed herein. In one implementation, a system includes a transmitter sending a video stream over a wireless link to a receiver. The transmitter compresses frames of the video stream prior to sending the frames to the receiver. For each block of pixels of a given frame, the transmitter selects a compression level to apply to the block based on the distance within the given frame from the block to the focus region, with the compression level increasing as the distance from the focus region increases. As used herein, the term “focus region” is defined as the portion of a half frame where each eye is expected to be focusing when a user is viewing the frame. In some cases, the “focus region” is determined based at least in part on an eye-tracking sensor detecting the location within the half frame where the eye is pointing. In one implementation, the size of the focus region varies according to one or more factors (e.g., link quality). The transmitter encodes each block with the selected compression level and then conveys the encoded blocks to a receiver to be displayed.

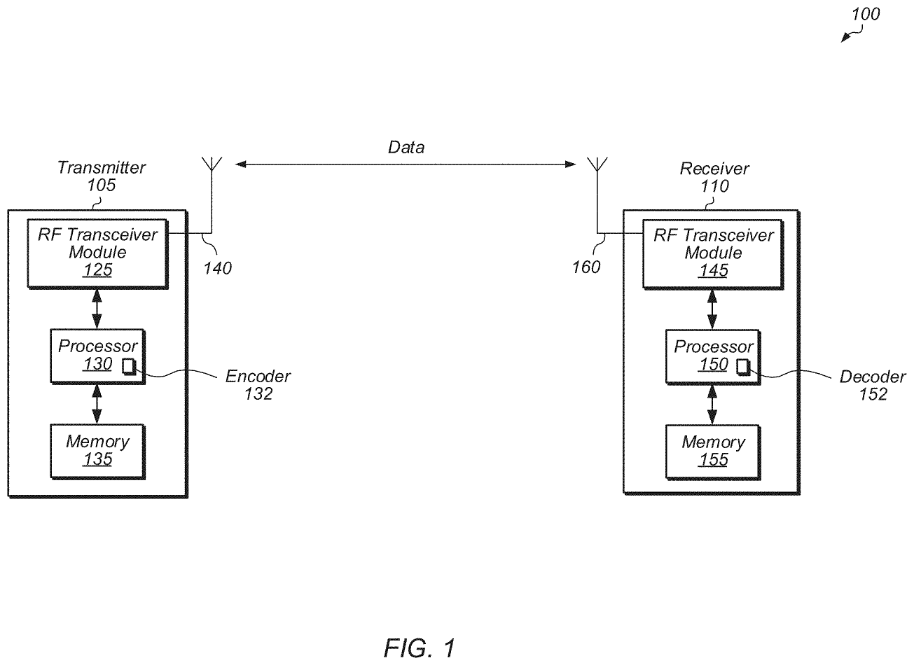

Referring now to FIG. 1, a block diagram of one implementation of a system 100 is shown. System 100 includes at least a first communications device (e.g., transmitter 105) and a second communications device (e.g., receiver 110) operable to communicate with each other wirelessly. It is noted that transmitter 105 and receiver 110 can also be referred to as transceivers. In one implementation, transmitter 105 and receiver 110 communicate wirelessly over the unlicensed 60 Gigahertz (GHz) frequency band. For example, in this implementation, transmitter 105 and receiver 110 communicate in accordance with the Institute of Electrical and Electronics Engineers (IEEE) 802.11ad standard (i.e., WiGig). In other implementations, transmitter 105 and receiver 110 communicate wirelessly over other frequency bands and/or by complying with other wireless communication protocols, whether according to a standard or otherwise. For example, other wireless communication protocols that can be used include, but are not limited to, Bluetooth®, protocols utilized with various wireless local area networks (WLANs), WLANs based on the Institute of Electrical and Electronics Engineers (IEEE) 802.11 standards (i.e., WiFi), mobile telecommunications standards (e.g., CDMA, LTE, GSM, WiMAX), etc.

Wireless communication devices that operate within extremely high frequency (EHF) bands, such as the 60 GHz frequency band, are able to transmit and receive signals using relatively small antennas. However, such signals are subject to high atmospheric attenuation when compared to transmissions over lower frequency bands. In order to reduce the impact of such attenuation and boost communication range, EHF devices typically incorporate beamforming technology. For example, the IEEE 802.11ad specification details a beamforming training procedure, also referred to as sector-level sweep (SLS), during which a wireless station tests and negotiates the best transmit and/or receive antenna combinations with a remote station. In various implementations, transmitter 105 and receiver 110 perform periodic beamforming training procedures to determine the optimal transmit and receive antenna combinations for wireless data transmission.

In one implementation, transmitter 105 and receiver 110 have directional transmission and reception capabilities, and the exchange of communications over the link utilizes directional transmission and reception. Each directional transmission is a transmission that is beamformed so as to be directed towards a selected transmit sector of antenna 140. Similarly, directional reception is performed using antenna settings optimized for receiving incoming transmissions from a selected receive sector of antenna 160. The link quality can vary depending on the transmit sectors selected for transmissions and the receive sectors selected for receptions. The transmit sectors and receive sectors which are selected are determined by system 100 performing a beamforming training procedure.

Transmitter 105 and receiver 110 are representative of any type of communication devices and/or computing devices. For example, in various implementations, transmitter 105 and/or receiver 110 can be a mobile phone, tablet, computer, server, head-mounted display (HMD), television, another type of display, router, or other types of computing or communication devices. In one implementation, system 100 executes a virtual reality (VR) application for wirelessly transmitting frames of a rendered virtual environment from transmitter 105 to receiver 110. In other implementations, other types of applications can be implemented by system 100 that take advantage of the methods and mechanisms described herein.

In one implementation, transmitter 105 includes at least radio frequency (RF) transceiver module 125, processor 130, memory 135, and antenna 140. RF transceiver module 125 transmits and receives RF signals. In one implementation, RF transceiver module 125 is a mm-wave transceiver module operable to wirelessly transmit and receive signals over one or more channels in the 60 GHz band. RF transceiver module 125 converts baseband signals into RF signals for wireless transmission, and RF transceiver module 125 converts RF signals into baseband signals for the extraction of data by transmitter 105. It is noted that RF transceiver module 125 is shown as a single unit for illustrative purposes. It should be understood that RF transceiver module 125 can be implemented with any number of different units (e.g., chips) depending on the implementation. Similarly, processor 130 and memory 135 are representative of any number and type of processors and memory devices, respectively, that are implemented as part of transmitter 105. In one implementation, processor 130 includes encoder 132 to encode (i.e., compress) a video stream prior to transmitting the video stream to receiver 110. In other implementations, encoder 132 is implemented separately from processor 130. In various implementations, encoder 132 is implemented using any suitable combination of hardware and/or software.

Transmitter 105 also includes antenna 140 for transmitting and receiving RF signals. Antenna 140 represents one or more antennas, such as a phased array, a single element antenna, a set of switched beam antennas, etc., that can be configured to change the directionality of the transmission and reception of radio signals. As an example, antenna 140 includes one or more antenna arrays, where the amplitude or phase for each antenna within an antenna array can be configured independently of other antennas within the array. Although antenna 140 is shown as being external to transmitter 105, it should be understood that antenna 140 can be included internally within transmitter 105 in various implementations. Additionally, it should be understood that transmitter 105 can also include any number of other components which are not shown to avoid obscuring the figure. Similar to transmitter 105, the components implemented within receiver 110 include at least RF transceiver module 145, processor 150, decoder 152, memory 155, and antenna 160, which are analogous to the components described above for transmitter 105. It should be understood that receiver 110 can also include or be coupled to other components (e.g., a display).

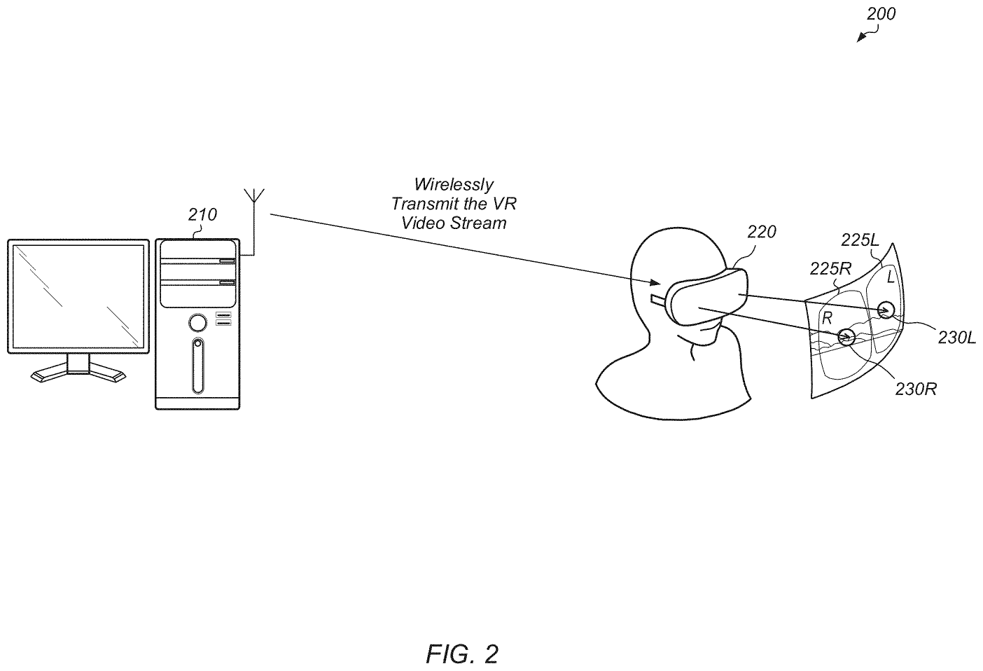

Turning now to FIG. 2, a block diagram of one implementation of a wireless virtual reality (VR) system 200 is shown. System 200 includes at least computer 210 and head-mounted display (HMD) 220. Computer 210 is representative of any type of computing device which includes one or more processors, memory devices, input/output (I/O) devices, RF components, antennas, and other components indicative of a personal computer or other computing device. In other implementations, other computing devices, besides a personal computer, are utilized to send video data wirelessly to head-mounted display (HMD) 220. For example, computer 210 can be a gaming console, smart phone, set top box, television set, video streaming device, wearable device, a component of a theme park amusement ride, or otherwise. Also, in other implementations, HMD 220 can be a computer, desktop, television or other device used as a receiver connected to a HMD or other type of display.

Computer 210 and HMD 220 each include circuitry and/or components to communicate wirelessly. It is noted that while computer 210 is shown as having an external antenna, this is shown merely to illustrate that the video data is being sent wirelessly. It should be understood that computer 210 can have an antenna which is internal to the external case of computer 210. Additionally, while computer 210 can be powered using a wired power connection, HMD 220 is typically battery powered. Alternatively, computer 210 can be a laptop computer (or another type of device) powered by a battery.

In one implementation, computer 210 includes circuitry which dynamically renders a representation of a VR environment to be presented to a user wearing HMD 220. For example, in one implementation, computer 210 includes one or more graphics processing units (GPUs) executing program instructions so as to render a VR environment. In other implementations, computer 210 includes other types of processors, including a central processing unit (CPU), application specific integrated circuit (ASIC), field programmable gate array (FPGA), digital signal processor (DSP), or other processor types. HMD 220 includes circuitry to receive and decode a compressed bit stream sent by computer 210 to generate frames of the rendered VR environment. HMD 220 then drives the generated frames to the display integrated within HMD 220.

Within each image that is displayed on HMD 220, the scene 225R being displayed on the right side 225R of HMD 220 includes a focus region 230R while the scene 225L being displayed on the left side of HMD 220 includes a focus region 230L. These focus regions 230R and 230L are indicated by the circles within the expanded right side 225R and left side 225L, respectively, of HMD 220. In one implementation, the locations of focus regions 230R and 230L within the right and left half frames, respectively, are determined based on eye-tracking sensors within HMD 220. In this implementation, the eye tracking data is provided as feedback to the encoder and optionally to the rendering source of the VR video. In some cases, the eye tracking data feedback is generated at a frequency higher than the VR video frame rate, and the encoder is able to access the feedback and update the encoded video stream on a per-frame basis. In some cases, the eye tracking is not performed on HMD 220, but rather, the facial video is sent back to the rendering source for further processing to determine the eye's position and movement. In another implementation, the locations of focus regions 230R and 230L are specified by the VR application based on where the user is expected to be looking. It is noted that the size of focus regions 230R and 230L can vary according to the implementation. Also, the shape of focus regions 230R and 230L can vary according to the implementation, with focus regions 230R and 230L defined as ellipses in another implementation. Other types of shapes can also be utilized for focus regions 230R and 230L in other implementations.

In one implementation, if HMD 220 includes eye tracking sensors to track the in-focus region based on where the user's eyes are pointed, then focus regions 230R and 230L can be relatively smaller. Otherwise, if HMD 220 does not include eye tracking sensors, and the focus regions 230R and 230L are determined based on where the user is expected to be looking, then focus regions 230R and 230L can be relatively larger. In other implementations, other factors can cause the sizes of focus regions 230R and 230L to be adjusted. For example, in one implementation, as the link quality between computer 210 and HMD 220 decreases, the size of focus regions 230R and 230L decreases.

In one implementation, the encoder uses the lowest amount of compression for blocks within focus regions 230R and 230L to maintain the highest quality and highest level of detail for the pixels within these regions. It is noted that “blocks” can also be referred to as “slices” herein. As used herein, a “block” is defined as a group of contiguous pixels. For example, in one implementation, a block is a group of 8×8 contiguous pixels that form a square in the image being displayed. In other implementations, other shapes and/or other sizes of blocks are used. Outside of focus regions 230R and 230L, the encoder uses a higher amount of compression, resulting in a lower quality for the pixels being presented in these areas of the half-frames. This approach takes advantage of the human visual system with each eye having a large field of view but with the eye focusing on only a small area within the large field of view. Based on the way that the eyes and brain perceive visual data, a person will typically not notice the lower quality in the area outside of the focus region.

In one implementation, the encoder increases the amount of compression that is used to encode a block within the image the further the block is from the focus region. For example, if a first block is a first distance from the focus region and a second block is a second distance from the focus region, with the second distance greater than the first distance, the encoder will encode the second block using a higher compression rate than the first block. This will result in the second block having less detail as compared to the first block when the second block is decompressed and displayed to the user. In one implementation, the encoder increases the amount of compression that is used by increasing a quantization strength level that is used when encoding a given block. For example, in one implementation, the quantization strength level is specified using a quantization parameter (QP) setting. In other implementations, the encoder increases the amount of compression that is used to encode a block by changing the values of other encoding settings.

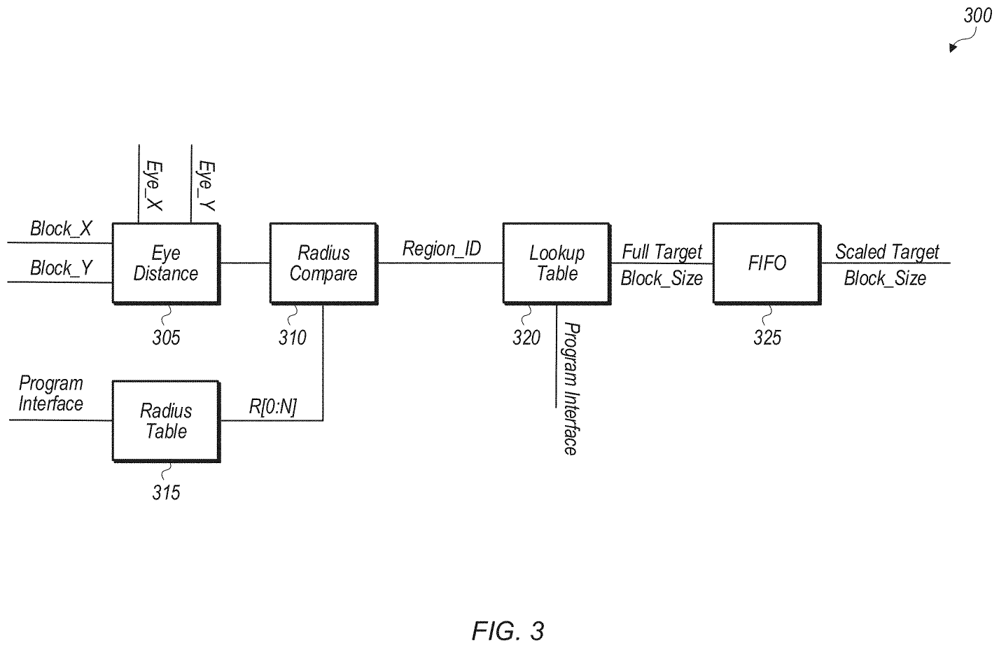

Referring now to FIG. 3, a block diagram of one implementation of control logic 300 for determining how much compression to apply to blocks of a frame is shown. In one implementation, control logic 300 includes eye distance unit 305, radius compare unit 310, radius table 315, lookup table 320, and first-in, first-out (FIFO) queue 325. In other implementations, control logic 300 can include other components and/or be organized in other suitable manners.

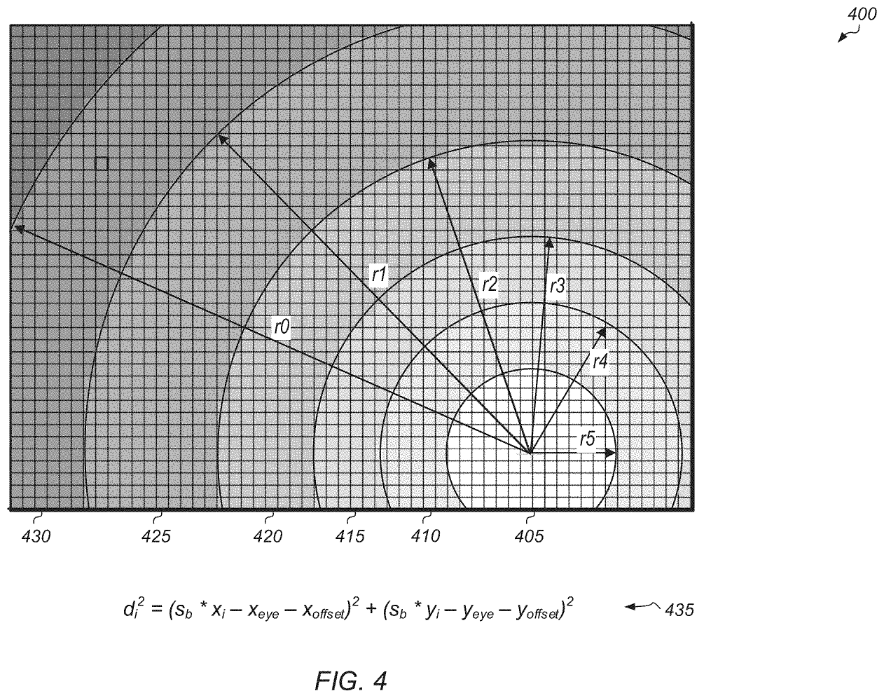

Eye distance unit 305 calculates the distance to a given block from the focus region of the particular half screen image (right or left eye). In one implementation, eye distance unit 305 calculates the distance using the coordinates of the given block (Block_X, Block_Y) and the coordinates of the center of the focus region (Eye_X, Eye_Y). An example of one formula 435 used to calculate the distance from a block to the focus region is shown in FIG. 4. In other implementations, other techniques for calculating distance from a block to the focus region can be utilized.

Based on the distance to a given block (or based on the square of the distance to the given block) from the center of the focus region, radius compare unit 310 determines which compression region the given block belongs to based on the radii R[0:N] provided by radius table 315. Any number “N” of radii are stored in radius table 315, with “N” a positive integer that varies according to the implementation. In one implementation, the radius-squared values are stored in the lookup table to eliminate the need for a hardware multiplier. In one implementation, the radius-squared values are programmed in radius table 315 in monotonically decreasing order such that entry zero specifies the largest circle, entry one specifies the second largest circle, and so on. In one implementation, unused entries in radius table 315 are programmed to zero. In one implementation, once the region to which the block belongs is identified, a region identifier (ID) for this region is used to index into lookup table 320 to extract a full target block size corresponding to the region ID. It should be understood that in other implementations, the focus regions can be represented with other types of shapes (e.g., ellipses) other than circles. The regions outside of the focus regions can also be shaped in the same manner as the focus regions. In these implementations, the techniques for determining which region a block belongs to can be adjusted to account for the specific shapes of the focus regions and external regions.

The output from lookup table 320 is a full target compressed block size for the block. In one implementation, the target block size is scaled with a compression ratio (or c_ratio) value before being written into FIFO 325 for later use as wavelet blocks are processed. Scaling by a function of c_ratio produces smaller target block sizes which is appropriate for reduced radio frequency (RF) link capacity. At a later point in time when the blocks are processed by an encoder, the encoder retrieves the scaled target block sizes from FIFO 325. In one implementation, for each block being processed, the encoder selects a compression level for compressing the block to meet the scaled target block size.

Turning now to FIG. 4, a diagram 400 of one implementation of concentric regions, corresponding to different compression levels, outside of a focus region of a half frame is shown. Each box in diagram 400 represents a slice of a half frame, with the slice including any number of pixels with the number varying according to the implementation. In each half of the screen, each slice's distance from the eye fixation point (either predicted or determined) is determined using formula 435 at the bottom of FIG. 4. In formula 435, S_{b} is the slice size. In one implementation, S_{b} is either 8 or 16. In other implementations, S_{b} can be other sizes. The variables X_{offset} and Y_{offset} adjust for the fact that slice (x, y) is relative to the top-left of the image and that x_{eye} and y_{eye} are relative to the center of each half of the screen. The slice_size divided by two is also added to each of x_{offset} and y_{offset} to account for the fact (S_{b}*Xᵢ, S_{b}*Yᵢ) is the top-left of each slice and the goal is to determine if the center of each slice falls inside or outside of each radius.

Then, after calculating dᵢ² using a formula such as formula 435, dᵢ² is compared to the square of each of “N” radii (r₀, r₁, r₂, . . . r_{N}) to determine which compression region the slice belongs to, where N is a positive integer. In the implementation shown in FIG. 4, N is equal to 5, but it should be understood that this is shown merely for illustrative purposes. For example, in this implementation, region 405 is the focus region with radius indicated by arrow r5, region 410 is the region adjacent to the focus region with radius indicated by arrow r4, region 415 is the next larger region with radius indicated by arrow r3, region 420 is the next larger region with radius indicated by arrow r2, region 425 is the next larger region with radius indicated by arrow r1, and region 430 is the largest region shown in diagram 400 with radius indicated by arrow r0. In another implementation, N is equal to 64 while in other implementations, N can be any of various other suitable integer values.

Based on the distance to a given slice (or based on the square of the distance to the given slice) from the center of the focus region 405, the encoder determines to which compression region the given slice belongs. In one implementation, once the region to which the slice belongs is identified, a region identifier (ID) is used to index into a lookup table to retrieve a target slice length. The lookup table mapping allows arbitrary mapping of region ID to slice size.

In one implementation, the output from the lookup table is a full target compressed size for the slice. The “region ID” can also be referred to as a “zone ID” herein. The target size is scaled with a compression ratio (or c_ratio) value before being written into a FIFO for later use as wavelet slices are processed. Scaling by some function of c_ratio produces smaller target slice sizes which is appropriate for reduced radio frequency (RF) link capacity.

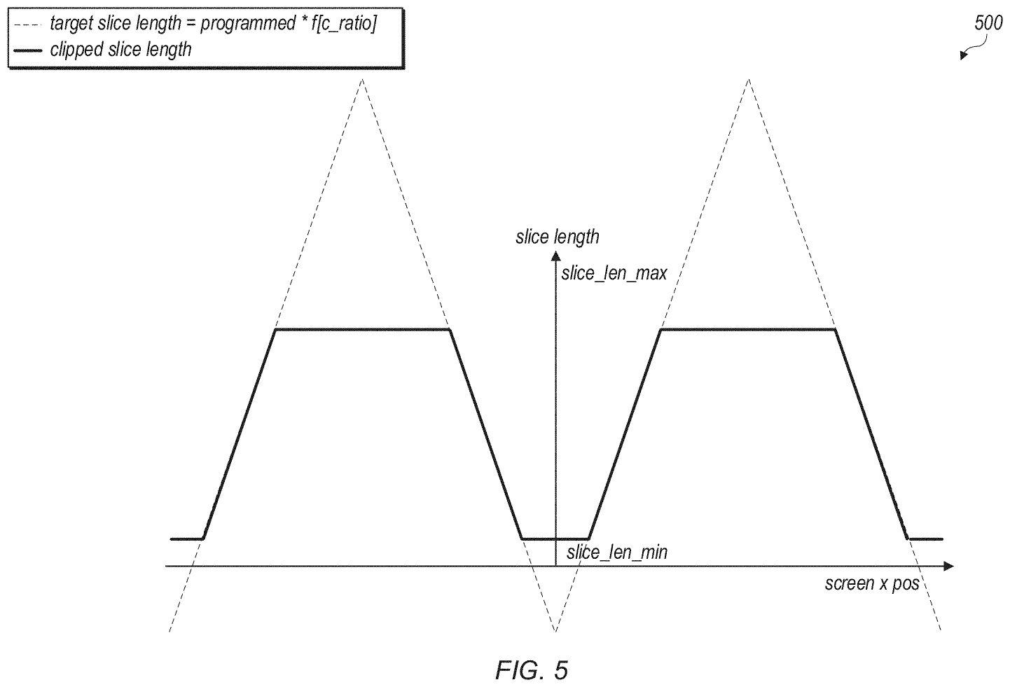

Referring now to FIG. 5, a diagram 500 of one implementation of clipping of the scaled target slice sizes is shown. In various implementations, as the compression ratio (or c_ratio) varies, the encoder tries to keep the central screen regions at a high quality. Diagram 500 illustrates one example of the clipping of scaled target slice sizes for one particular compression ratio setting. The dashed line in diagram 500 represents the target slice length which is equal to the programmed slice length multiplied by the compression ratio. The solid line in diagram 500 represents the clipped slice length.

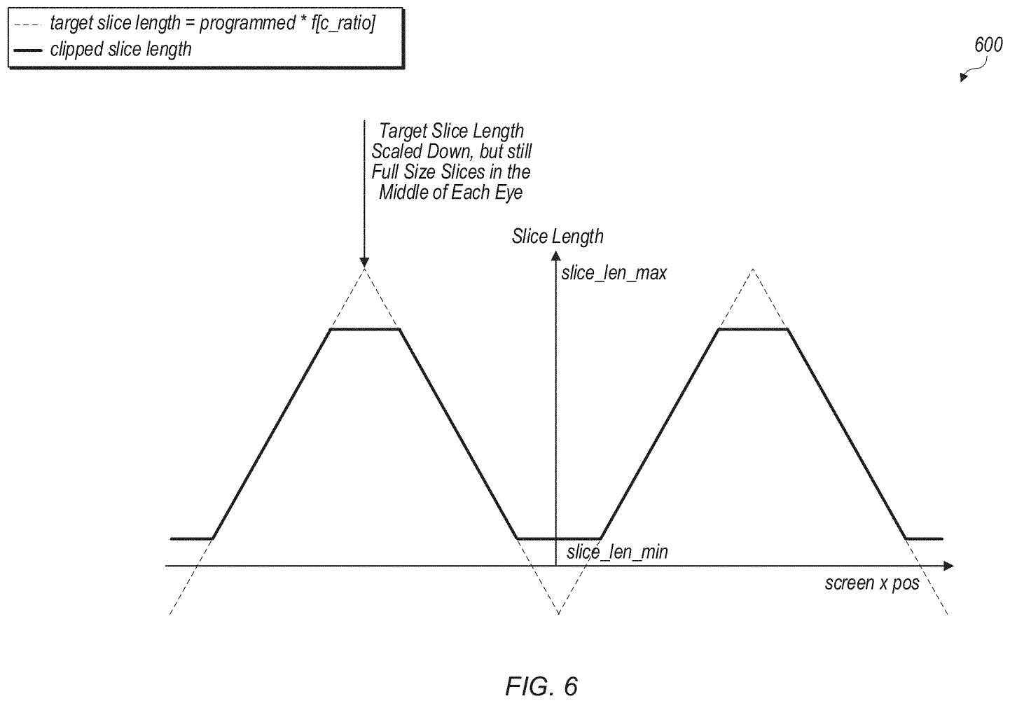

Turning now to FIG. 6, a diagram 600 of another implementation of clipping of the scaled target slice sizes is shown. Diagram 600 is intended to show a different compression ratio as compared to diagram 500 (of FIG. 5). Accordingly, diagram 600 illustrates the clipping of the scaled target slice sizes for a higher compression ratio than the compression ratio used in the implementation associated with diagram 500. Similar to diagram 500, the dashed line in diagram 600 represents the target slice length while the solid line represents the clipped slice length.

Diagrams 500 and 600, of FIG. 5 and FIG. 6, respectively, show how target slice sizes are programmed so that the central regions of each eye remain at a relatively high quality even as the compression ratio is increased. The changes from diagram 500 to 600 show that clipping of the scaled target slice sizes results in an area in the center that is at a high quality and remains so as peripheral areas are compressed more. It is noted that target slice values can be larger than the maximum slice length (or slice_len_max) (up to 16,383 in one implementation) or even negative since clipping will bring them back into the appropriate range. Also, it should be understood that diagrams 500 and 600 are shown for illustration purposes and diagrams 500 and 600 do not have to be straight lines. In a typical implementation, diagrams 500 and 600 will be stair-stepped due to only having N radii and N associated target slice lengths. The overall shape of diagrams 500 and 600 can be pyramids as shown, bell-shaped, or otherwise.

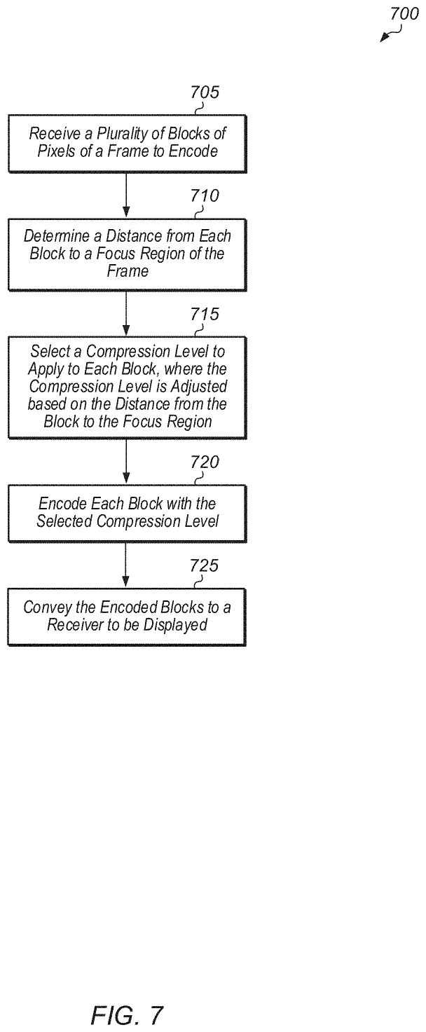

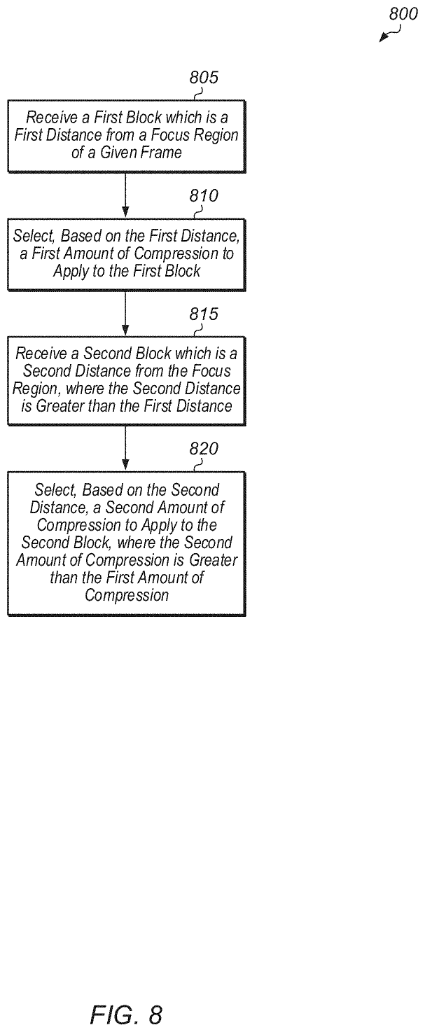

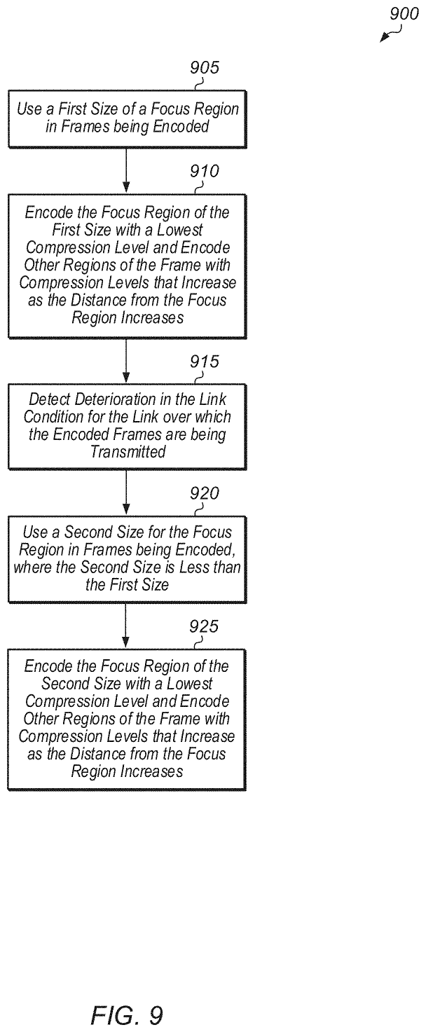

Turning now to FIG. 7, one implementation of a method 700 for adjusting a compression level based on distance from the focus region is shown. For purposes of discussion, the steps in this implementation and those of FIG. 8-9 are shown in sequential order. However, it is noted that in various implementations of the described methods, one or more of the elements described are performed concurrently, in a different order than shown, or are omitted entirely. Other additional elements are also performed as desired. Any of the various systems or apparatuses described herein are configured to implement method 700.

An encoder receives a plurality of blocks of pixels of a frame to encode (block 705). In one implementation, the encoder is part of a transmitter or coupled to a transmitter. The transmitter can be any type of computing device, with the type of computing device varying according to the implementation. In one implementation, the transmitter renders frames of a video stream as part of a virtual reality (VR) environment. In other implementations, the video stream is generated for other environments. In one implementation, the encoder and the transmitter are part of a wireless VR system. In other implementations, the encoder and the transmitter are included in other types of system. In one implementation, the encoder and the transmitter are integrated together into a single device. In other implementations, the encoder and the transmitter are located in separate devices.

The encoder determines a distance from each block to a focus region of the frame (block 710). In another implementation, the square of the distance from each block to the focus region is calculated in block 710. In one implementation, the focus region of the frame is determined by tracking eye movement of the user (eye tracking based). In such an embodiment, the position at which the eyes are fixated may be embedded in the video sequence (e.g., in a non-visible or non-focus region area). In another implementation, the focus region is specified by the software application based on where the user is expected to be looking (non-eye tracking based). In some embodiments, both eye tracking and non-eye tracking based approaches are available as modes of operation. In one embodiment, a given mode is programmable. In some embodiments, the mode may change dynamically based on various detected conditions (e.g., available bandwidth, a measure of perceived image quality, available hardware resources, power management schemes, or otherwise). In other implementations, the focus region is determined in other manners. In one implementation, the size of the focus region is adjustable based on one or more factors. For example, in one implementation, the size of the focus region is decreased as the link conditions deteriorate.

Next, the encoder selects a compression level to apply to each block, where the compression level is adjusted based on the distance from the block to the focus region (block 715). For example, in one implementation, the compression level is increased the further the block is from the focus region. Then, the encoder encodes each block with the selected compression level (block 720). Next, a transmitter conveys the encoded blocks to a receiver to be displayed (block 725). The receiver can be any type of computing device. In one implementation, the receiver includes or is coupled to a head-mounted display (HMD). In other implementations, the receiver can be other types of computing devices. After block 725, method 700 ends.

Turning now to FIG. 8, one implementation of a method 800 for selecting an amount of compression to apply to blocks based on distance from the focus region is shown. An encoder receives a first block which is a first distance from a focus region of a given frame (block 805). Next, the encoder selects, based on the first distance, a first amount of compression to apply to the first block (block 810). It is noted that an “amount of compression” can also be referred to herein as a “compression level”. Also, the encoder receives a second block which is a second distance from the focus region, and it is assumed for the purposes of this discussion that the second distance is greater than the first distance (block 815). It should be understood that the terms “first” and “second” that are used to refer to the first block and second block do not refer to any specific ordering between the two blocks but rather are used merely as labels to distinguish between the two blocks. There are places in the half-frame where a subsequent block is closer to the focus region than a preceding block and there are other places where the reverse is true. It is also possible that two consecutive blocks will be equidistant from the focus region. Next, the encoder selects, based on the second distance, a second amount of compression to apply to the second block, where the second amount of compression is greater than the first amount of compression (block 820). After block 820, method 800 ends.

It is noted that the encoder receives any number of blocks and uses any number of different amounts of compression to apply to the blocks based on the distance of each block to the focus region. For example, in one implementation, the encoder partitions an image into 64 different concentric regions, with each region applying a different amount of compression to blocks within the region. In other implementations, the encoder partitions the image into other numbers of different regions for the purpose of determining how much compression to apply.

Referring now to FIG. 9, one implementation of a method 900 for adjusting a size of a focus region based on a change in the link condition is shown. An encoder uses a first size of a focus region in frames being encoded (block 905). Next, the encoder encodes the focus region of the first size with a lowest compression level and encodes other regions of the frame with compression levels that increase as the distance from the focus region increases (block 910). At a later point in time, the transmitter detects deterioration in the link condition for the link over which the encoded frames are being transmitted (block 915). In one implementation, the transmitter and/or a receiver generates a measurement of the link condition (i.e., link quality) of a wireless link during the implementation of one or more beamforming training procedures. In this implementation, the deterioration in the link condition is detected during a beamforming training procedure. In other implementations, the deterioration in the link condition is determined using other suitable techniques (i.e., based on a number of dropped packets).

In response to detecting the deterioration in the link condition, the encoder uses a second size for the focus region in frames being encoded, where the second size is less than the first size (block 920). Next, the encoder encodes the focus region of the second size with a lowest compression level and encodes other regions of the frame with compression levels that increase as the distance from the focus region increases (block 925). After block 925, method 900 ends. It is noted that method 900 is intended to illustrate the scenario when the size of the focus region changes based on a change in the link condition. It should be understood that method 900, or a suitable variation of method 900, can be performed on a periodic basis to change the size of the focus region based on changes in the link condition. Generally speaking, according to one implementation of method 900, as the link condition improves the size of the focus region increases, while as the link condition deteriorates the size of the focus region decreases.

In various implementations, program instructions of a software application are used to implement the methods and/or mechanisms described herein. For example, program instructions executable by a general or sped al purpose processor are contemplated. In various implementations, such program instructions can be represented by a high level programming language. In other implementations, the program instructions can be compiled from a high level programming language to a binary, intermediate, or other form. Alternatively, program instructions can be written that describe the behavior or design of hardware. Such program instructions can be represented by a high-level programming language, such as C. Alternatively, a hardware design language (HDL) such as Verilog can be used.

In various implementations, the program instructions are stored on any of a variety of non-transitory computer readable storage mediums. The storage medium is accessible by a computing system during use to provide the program instructions to the computing system for program execution. Generally speaking, such a computing system includes at least one or more memories and one or more processors configured to execute program instructions.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

1. A system comprising:
an encoder configured to:
receive a plurality of blocks of pixels of a frame to encode;
encode each block with a selected compression level, wherein blocks within a focus region of the frame are compressed with a compression level different from that of blocks of the frame that are outside the focus region; and
vary a size of the focus region based at least in part on a quality of the link;
a transmitter configured to convey the encoded blocks via a link to a receiver to be displayed.

2. The system as recited in claim 1, wherein regions closer to the focus region are compressed with lower compression than regions further from the focus region.

3. The system as recited in claim 1, wherein:
a separate focus region is specified for each half of the frame; and
each separate focus region is a portion of a half frame where each eye is expected to be focusing when a user is viewing the frame.

4. The system as recited in claim 1, wherein the encoder is further configured to select a compression level to apply to each given block of the frame based on a distance from the given block to the focus region.

5. The system as recited in claim 4, wherein the second compression level results in a lower quality being preserved for the second block compared to a quality which is preserved for the first block based on the first compression level.

6. The system as recited in claim 1, wherein the encoder is further configured to:
receive a request to reduce a size of a compressed frame; and
responsive to receiving the request, maintain a compression level used to compress the focus region while increasing one or more compression levels used to compress regions outside of the focus region.

7. The system as recited in claim 1, wherein the system is configured to decrease a size of the focus region as link quality deteriorates.

8. A method comprising:
receiving, by an encoder, a plurality of blocks of pixels of a frame to encode;
encoding each block with a selected compression level, wherein blocks within a focus region of the frame are compressed with a compression level different from that of blocks of the frame that are outside the focus region;
conveying the encoded blocks via a link to a receiver to be displayed; and
varying a size of the focus region based at least in part on a quality of the link.

9. The method as recited in claim 8, wherein regions closer to the focus region are compressed with lower compression than regions further from the focus region.

10. The method as recited in claim 8, wherein a separate focus region is specified for each half of the frame, and wherein each separate focus region is a portion of a half frame where each eye is expected to be focusing when a user is viewing the frame.

11. The method as recited in claim 8, further comprising selecting a compression level to apply to each given block of the frame based on a distance from the given block to the focus region.

12. The method as recited in claim 11, wherein the second compression level results in a lower quality being preserved for the second block compared to a quality which is preserved for the first block based on the first compression level.

13. The method as recited in claim 8, further comprising:
receiving, by the encoder, a request to reduce a size of a compressed frame; and
responsive to receiving the request, maintaining a compression level used to compress the focus region while increasing one or more compression levels used to compress regions outside of the focus region.

14. The method as recited in claim 8, further comprising decoding, by a receiver with a head-mounted display (HMD), the encoded blocks of the frame and displaying the decompressed version of the frame on the HMD.

15. An apparatus comprising:
a processor; and
a radio frequency (RF) transceiver module;
wherein the processor is configured to:
receive a plurality of blocks of pixels of a frame to encode;
encode each block with a selected compression level, wherein blocks within a focus region of the frame are compressed with a compression level different from that of blocks of the frame that are outside the focus region; and
vary a size of the focus region based at least in part on a quality of the link;
wherein the RF transceiver module is configured to convey the encoded blocks via a link to a receiver to be displayed.

16. The apparatus as recited in claim 15, wherein regions closer to the focus region are compressed with lower compression than regions further from the focus region.

17. The apparatus as recited in claim 15, wherein a separate focus regions is specified for each half of the frame, and wherein each separate focus region is a portion of a half frame where each eye is expected to be focusing when a user is viewing the frame.

18. The apparatus as recited in claim 15, wherein the processor is further configured to select a compression level to apply to each given block of the frame based on a distance from the given block to the focus region.

19. The apparatus as recited in claim 18, wherein the second compression level results in a lower quality being preserved for the second block compared to a quality which is preserved for the first block based on the first compression level.

20. The apparatus as recited in claim 15, wherein the processor is further configured to:
receive a request to reduce a size of a compressed frame; and
responsive to receiving the request, maintain a compression level used to compress the focus region while increasing one or more compression levels used to compress regions outside of the focus region.
